(19) United States
(12) Patent Application Publication
(10) Pub. No.: US 2012/0306804 A1
(43) Pub. Date: Dec. 6, 2012

(54) TOUCH DEVICE

(75) Inventors: ER-HAO CHEN, NEW TAIPEI CITY (TW); TAO-CHENG YEN, NEW TAIPEI CITY (TW); YI-PING HSU, NEW TAIPEI CITY (TW)

(73) Assignees: LITE-ON TECHNOLOGY CORPORATION, TAIPEI CITY (TW); SILITEK ELECTRONIC (GUANGZHOU) CO., LTD., GUANGZHOU (CN)

(21) Appl. No.: 13/343,020

(22) Filed: Jan. 4, 2012

(30) Foreign Application Priority Data
Jun. 1, 2011 (CN) 201110145810.2

(51) Int. Cl. G06F 3/044; G06F 3/041

(52) U.S. Cl. 345/174; 345/173

(57) ABSTRACT

A touch device including a first touch-sensing unit, a second touch-sensing unit, a touch-sensing strip module, and a control module is disclosed for controlling functions performed by an electronic device. The first and the second touch-sensing unit respectively generate a first and a second touch signal while touched. The touch-sensing strip module includes sequentially arranged M third touch-sensing units, and the touch-sensing strip module generates a first sliding signal when the third touch-sensing units are touched in a first predetermined sequence. The control module drives the electric device to perform a first function while receiving the first touch signal and the first sliding signal simultaneously, and the control module drives the electric device to perform a second function while receiving the second touch signal and the first sliding signal simultaneously.

### BACKGROUND OF THE INVENTION

1. Field of the Invention

The present invention relates to a touch device; in particular, to a touch device which is capable of realizing multi-axis touch control.

2. Description of Related Art

As the technology progresses, electronic devices have been widely utilized in people's daily lives. Touch devices allowing for users to operate the electronic devices in an instinctive manner have been emerging to at least somewhat become the primary option of the input device in certain electronic devices including notebooks and tablet computers. Besides, the growing popularity of the touch devices may be also attributed to usage of reduced mechanical structures when compared with traditional input devices such as mouse/keyboards, and the capability of multi-point or multi-axis control.

In general, the traditional touch device usually needs a plurality of touch-sensing strip modules to realize multi-axis touch control, with each of the touch-sensing strip modules corresponding to and being associated with control of a single axis. For example, when a touch device is configured to perform four functions such as zooming in/out, scrolling, adjusting the brightness, and adjusting the volume of an electronic device, four touch-sensing strip modules in total are required and each of the four touch-sensing strip modules is employed for each of the four functions. In other words, when each of the touch-sensing strip modules is touched the corresponding function would be performed. In practice, each of the touch-sensing strip modules further needs four touch-sensing units to precisely detect a sliding direction when the touch-sensing strip module is touched, and thus sixteen touch-sensing units are necessary for realizing the 4-axis touch control.

### SUMMARY OF THE INVENTION

The primary objective of the present invention is to provide a touch device with a touch-sensing strip module thereof the touch device that is capable of realizing multi-axis touch control. Therefore, the touch device of the present invention can greatly reduce the amount of the touch-sensing strip modules and the touch-sensing units.

In order to achieve the aforementioned objective, according to one embodiment of the present invention, a touch device is provided to control an electronic device. The touch device includes a first touch-sensing unit, a second touch-sensing unit, a touch-sensing strip module, and a control module. The first and the second touch-sensing unit respectively generate a first and a second touch signal while touched. The touch-sensing strip module includes sequentially arranged M third touch-sensing units, and the touch-sensing strip module generates a first sliding signal when the plurality of third touch-sensing units are touched in a first predetermined sequence, wherein M is an integer larger than 1. The control module drives the electronic device to perform a first function while receiving the first touch signal and the first sliding signal simultaneously, and the control module drives the electronic device to perform a second function while receiving the second touch signal and the first sliding signal simultaneously.

In an explanatory embodiment of the present invention, the touch-sensing strip module generates a second sliding signal while the M third touch-sensing units are touched in a second predetermined sequence. The control module controls the electronic device to perform a third function while detecting the first touch signal and the second sliding signal at the same time, and the control module controls the electronic device to perform a fourth function while detecting the second touch signal and the second sliding signal at the same time.

In another explanatory embodiment of the present invention, the touch device further comprises a comparing module coupled with the first touch-sensing unit, the second touch-sensing unit, and the control module respectively. The comparing module is configured for comparing a magnitude of the first touch signal and the second touch signal, and transmitting one of the first touch signal and the second touch signal with the larger magnitude to the control module.

In another explanatory embodiment of the present invention, the first touch-sensing unit, the second touch-sensing unit, and the touch-sensing strip module are coplanarly disposed on a substrate, and the touch-sensing strip module is disposed between the first touch-sensing unit and the second touch-sensing unit. Besides, the touch device further comprises a housing for containing the first touch-sensing unit, the second touch-sensing unit, and the touch-sensing strip module. A first groove and a second groove are formed on an exterior surface of the housing. The first groove is configured to ensure the first touch-sensing unit and the touch-sensing strip module could be simultaneously touched, and the second groove is configured to ensure the second touch-sensing unit and the touch-sensing strip module could be simultaneously touched.

To sum up, the touch device of the present invention can realize 2-axis touch control by disposing the first touch-sensing unit on one side of the touch-sensing strip module and disposing the second touch-sensing unit on the other side of the touch-sensing strip module. Thus the first touch-sensing unit and the touch-sensing strip module may define the first axis for the 2-axis touch control, and the second touch-sensing unit and the touch-sensing strip module may define the second axis of the 2-axis touch control. Therefore, the touch device of the present invention can greatly reduce the amount of the touch-sensing strip modules and the touch-sensing units.

In order to further the understanding regarding the present invention, the following embodiments are provided along with illustrations to facilitate the disclosure of the present invention.

### BRIEF DESCRIPTION OF THE DRAWINGS

FIG. 1 shows a block diagram of a touch device according to an embodiment of the present invention;

FIG. 2 shows a top view of the touch device according to an embodiment of the present invention;

FIG. 3 shows a top view of a touch device according to another embodiment of the present invention;

FIG. 4 shows a top view diagram of a touch device according to further another embodiment of the present invention;

FIG. 5A shows a perspective diagram of a touch device with a housing according to an embodiment of the present invention;

FIG. 5B shows a sectional diagram of the touch device with the housing according to FIG. 5A; and

FIG. 6 shows a sectional diagram of a touch device with a housing according to another embodiment of the present invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

For those skilled in the art, it is clear that said “touch the touch-sensing unit” shall not be limit to directly touch the touch-sensing unit by hands, it might, of course, represent any means which can lead to capacitance variation.

[Embodiment for Touch Device]

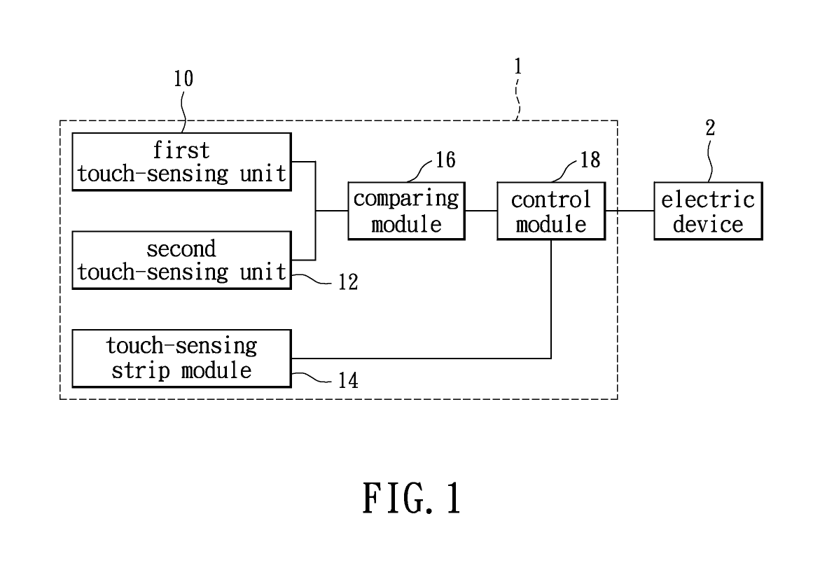

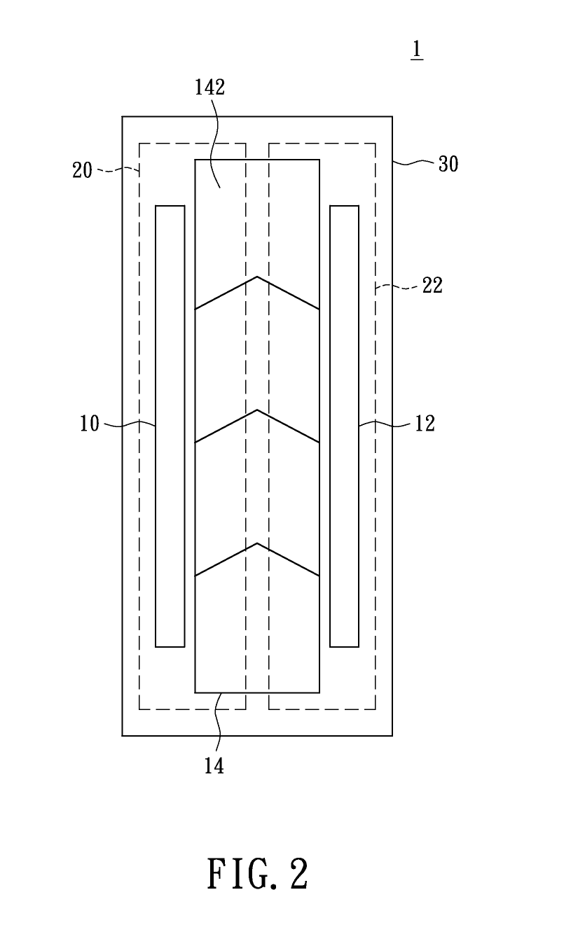

Referring to FIGS. 1 and 2, FIG. 1 shows a block diagram of a touch device 1 according to an embodiment of the present invention, and FIG. 2 shows a top view of the touch device according to an embodiment of the present invention. As shown in said figures, the touch device 1 is applied for controlling an electronic device 2, and the touch device 1 comprises a first touch-sensing unit 10, a second touch-sensing unit 12, a touch-sensing strip module 14, a comparing module 16, and a control module 18. The first touch-sensing unit 10 and the second touch-sensing unit 12 are electronically connected to the control module 18 through the comparing module 16. The touch-sensing strip module 14 is coupled with the control module 18. Said components of the touch device 1 will be further described in the follows.

The first touch-sensing unit 10 may be configured to generate a first touch signal when the first touch-sensing unit 10 is touched, and the second touch-sensing unit 12 may also generate a second touch signal when the second touch-sensing unit 12 is touched. In practice, when the first touch-sensing unit 10 is touched by a user, an original equivalent capacitance of the first touch-sensing unit 10 is correspondingly affected by the user, and the first touch-sensing unit 10 may generate the first touch signal as the result of variation in the equivalent capacitance. Similarly, when the second touch-sensing unit 12 is touched, an original equivalent capacitance of the second touch-sensing unit 12 is correspondingly affected as well. And the second touch-sensing unit 12 may generate the second touch signal because of the capacitance variation.

It is worth noting that the first touch-sensing unit 10 and the second touch-sensing unit 12 are not limited to strip-shaped plates as shown in figures. For example, the first touch-sensing unit 10 could further be a plurality of touch-sensing pads coupled to each other.

The touch-sensing strip module 14 has a plurality of third touch-sensing units 142 arranged in series. In one implementation, the touch-sensing strip module 14 includes M third touch-sensing units 142 arranged in series. When the M third touch-sensing units 142 are respectively touched in a first predetermined sequence, the touch-sensing strip module 14 correspondingly generates a first sliding signal. Since the M third touch-sensing units 142 may be closely disposed and arranged in strip shape, when the M third touch-sensing units 142 are touched in the first predetermined sequence the touch-sensing strip module 14 having the M third touch-sensing units 142 may be touched along a first direction indicative of a sliding touching of the touch-sensing strip module 14 along the first direction. Specifically, the k^{th} of the M third touch-sensing units 142 may generate a k^{th} third touch signal when touched, the (k+1)^{th} of the M third touch-sensing units 142 may generate a (k+1)^{th} third touch signal when touched, and the touch-sensing strip module 14 generates the first sliding signal when the touch-sensing strip module 14 detects the k^{th} third touch signal before detecting the (k+1)^{th} third touch signal.

As shown in the figures, in one implementation M could be 4. Therefore, when the 1^{st} third touch-sensing unit 142 is touched before the 2^{nd} to 4^{th} third touch-sensing units 142 are touched sequentially, a first touch event indicating the sliding touching of the touch-sensing strip module 14 may be considered taking place. In other words, since the 1^{st} to 4^{th} third touch-sensing units 142 have been touched sequentially the touch-sensing strip module 14 may receive a 1^{st} third touch signal, a 2^{nd} third touch signal, a 3^{rd} third touch signal, and a 4^{th} third touch signal in the same sequence. Therefore, the touch-sensing strip module 14 may conclude those third touch-sensing units are touched sequentially, and may thus generate the first sliding signal. It should be mentioned that the present invention does not limit how many third touch signals should be received by the touch-sensing strip module 14 before the touch-sensing strip module 14 may recognize the occurrence of the first touch event, those skilled in the art can reduce the necessary number of third touch signals by arranging the M third touch-sensing units properly.

On the other hand, the k^{th} of the M third touch-sensing units 142 generates a k^{th} third touch signal when touched, the (k−1)^{th} of the M third touch-sensing units 142 generates a (k−1)^{th} third touch signal when touched, and the touch-sensing strip module 14 generates the second sliding signal when the touch-sensing strip module 14 detects the k^{th} third touch signal before detecting the (k−1)^{th} third touch signal. For example, when the 4^{th} third touch-sensing unit 142 is touched before the 3^{rd} third touch-sensing unit 142, the 2^{nd} third touch-sensing unit 142, and the 1^{st} third touch-sensing unit 142, a corresponding second touch event may be considered taking place. In other words, from the perspective of the touch-sensing strip module 14 the touch-sensing strip module 14 may receive a 4^{th} third touch signal, a 3^{rd} third touch signal, a 2^{nd} third touch signal, and a 1^{st} third touch signal in sequence. Therefore, the touch-sensing strip module 14 may arrive at the conclusion that those third touch-sensing units 142 are touched in the same sequence, before generating the second sliding signal.

The comparing module 16 is configured to compare the magnitude of the first touch signal and the second touch signal, and transmit one of the first touch signal and the second touch signal with the larger magnitude to the control module 18. In practice, the magnitude of the first touch signal and the second touch signal are determined by the capacitance variation of the first touch-sensing unit 10 and the second touch-sensing unit 12. For example, when a certain area of the touch device 1 that is touched is closer to the first touch-sensing unit 10, the capacitance variation of the first touch-sensing unit 10 may be larger than the capacitance variation of the second touch-sensing unit 12. Therefore, the capacitance variation of the first touch-sensing unit 10 may be larger than the capacitance variation of the second touch-sensing unit 12, indicating the magnitude of the first signal is larger than the magnitude of the second touch signal. On the other hand, when the touched area is closer to the second touch-sensing unit 12, the capacitance variation of the second touch-sensing unit 12 may be larger than the capacitance variation of the first touch-sensing unit 10, and the magnitude of the second touch signal may be larger than the magnitude of the first touch signal accordingly.

By comparing the capacitance variation of the first touch-sensing unit 10 and the second touch-sensing unit 12, the comparing module 16 is configured to determine which part of the touch device 1 is touched. And in doing so the comparing module 16 may be capable of preventing the control module 18 from receiving false touch signals since the comparing module 16 may transmit only the first touch signal to the control module 18 when determining the touched area of the touch device 1 is closer to the first touch-sensing unit 10. Similarly, the comparing module 16 may transmit only the second touch signal to the control module 18 when determining the touched area of the touch device 1 is close to the second touch-sensing unit 12.

It is worth noting that the touch device 1 may not be necessary to have the comparing module 16 when the first touch-sensing unit 10 and the second touch-sensing unit 12 are disposed relatively away from each other, eliminating the possibility that the touching of the first touch-sensing unit 10 and that of the second touch-sensing unit 12 interfere with each other.

The control module 18 controls the electronic device 2 to perform a first function (such as scrolling the displayed image downwardly) when the control module 18 detects the first touch signal and the first sliding signal (such as sliding downwardly) at the same time. The control module 18 may further control the electronic device 2 to perform a second function (such as turning down the speaker volume) when the control module 18 detects the second touch signal and the first sliding signal (such as sliding downwardly) at the same time. Similarly, the control module 18 may control the electronic device 2 to perform a third function (such as scrolling the displayed image upwardly) when the control module 18 detects the first touch signal and the second sliding signal (such as sliding upwardly) at the same time. The control module 18, meanwhile, may be configured to control the electronic device 2 to perform a fourth function (such as turning up the speaker volume) when the control module 18 detects the second touch signal and the second sliding signal (such as sliding upwardly) at the same time.

The area covering both the first touch-sensing unit 10 and the touch-sensing strip module 14 may be defined as a first touch-sensing area 20, and the area covering both the second touch-sensing unit 12 and the touch-sensing strip module 14 may be defined as a second touch-sensing area 22. When any touching falls within the first touch-sensing area 20, the control module 18 may control the electronic device 2 to perform the first or the third function. Moreover, when any touching falls within the second touch-sensing area 22, the control module 18 may control the electronic device 2 to perform the second or the fourth function.

In practice, the first touch-sensing unit 10, the second touch-sensing unit 12, and the touch-sensing strip module 14 may be coplanarly disposed on the same side of a substrate 30. The present invention does not limit the material of the substrate 30, and does not limit the arrangement of the first touch-sensing unit 10, the second touch-sensing unit 12, and the touch-sensing strip module 14 disposed on the substrate 30. The person skilled in the art can design said arrangement as long as the first touch-sensing unit 10 and the touch-sensing strip module 14 may be touched simultaneously, and the second touch-sensing unit 12 and the touch-sensing strip module 14 may be touched simultaneously as well.

For example, the touch-sensing strip module 14 may be disposed between the first touch-sensing unit 10 and the second touch-sensing unit 12. The distance between the first touch-sensing unit 10 (or the second touch-sensing unit 12) and the touch-sensing strip module 14 may be designed by the person skilled in the art. In one implementation, the distance between the first touch-sensing unit 10 (or the second touch-sensing unit 12) and the touch-sensing strip module 14 may be less than the width of a finger to enhance the touch-sensing accuracy.

It is worth noting that the touch device 1 may only needs 6 touch-sensing units including one first touch-sensing unit 10, one second touch-sensing unit 12, and four third touch-sensing units 142 to realize the two-axis control. In contrast, the traditional touch device at least needs 8 touch-sensing units (2 touch-sensing strip modules) to realize the same two-axis control. Therefore, the touch device 1 can greatly reduce the amount and cost of the touch-sensing strip modules and the touch-sensing units.

[Another Embodiment for Touch Device]

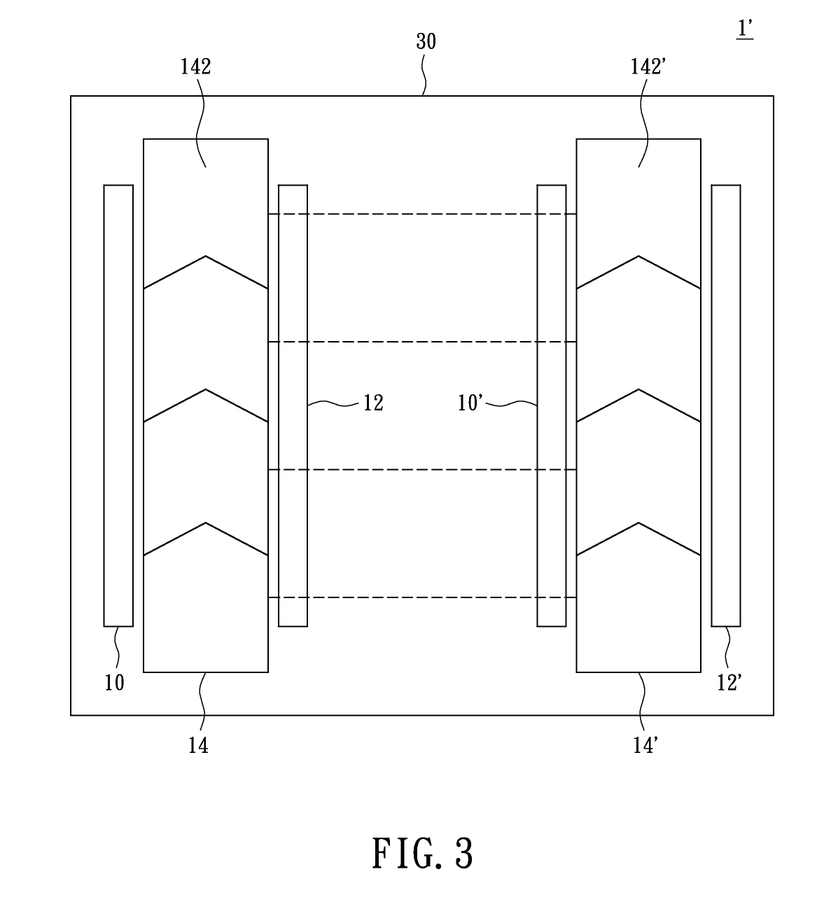

The 4-axis touch control may be realized by two independent sets of the touch devices operating separately or by the two sets of the touch devices 1 electronically connected in parallel. Referring to FIGS. 2 and 3, FIG. 3 shows a top view of a touch device 1′ according to another embodiment of the present invention. The touch device 1′ has two sets of the touch devices 1 electronically connected in parallel. And despite the touch-sensing strip module 14 and another touch-sensing strip module 14′ are disposed in a parallel fashion with respect to each other the spatial arrangement between them is not therefore limited. For example, in another implementation the touch-sensing strip module 14 and the touch-sensing strip module 14′ may be vertically disposed with respect to each other.

In the current embodiment, the first touch-sensing unit 10, the second touch-sensing unit 12, the first touch-sensing unit 10′, and the second touch-sensing unit 12′ are not coupled with each other, while the touch-sensing strip module 14 is electronically connected to the touch-sensing strip module 14′. Besides, each and every third touch-sensing units 142 of the touch-sensing strip module 14 may be electronically connected to the corresponding third touch-sensing units 142′ of the touch-sensing strip module 14′. In other words, the touch-sensing strip module 14 and the touch-sensing strip module 14′ share the third touch-sensing units 142 and 142′.

In addition, the touch device 1′ further includes two comparing modules (not shown in FIG. 3) and one control module (not shown in FIG. 3 either). The first touch-sensing unit 10 and the second touch-sensing unit 12 are coupled with the control module through one of the comparing modules, and the first touch-sensing unit 10′ and the second touch-sensing unit 12′ are coupled with the control module through the other comparing module. It is worth noting that the functions of the comparing modules and the control module are exactly the same as those described in the embodiment presented previously.

To sum up, the touch device 1 only needs eight touch-sensing units (two first touch-sensing units 10 and 10′, two second touch-sensing units 12 and 12′, four shared third touch-sensing units 142 and 142′) to realize the 4-axis touch control. In contrast, the traditional touch device at least needs 16 touch-sensing units (4 touch-sensing strip modules) to achieve the same goal.

[Embodiment for Touch Device which can be Touched by the User in Different Direction/Sequence]

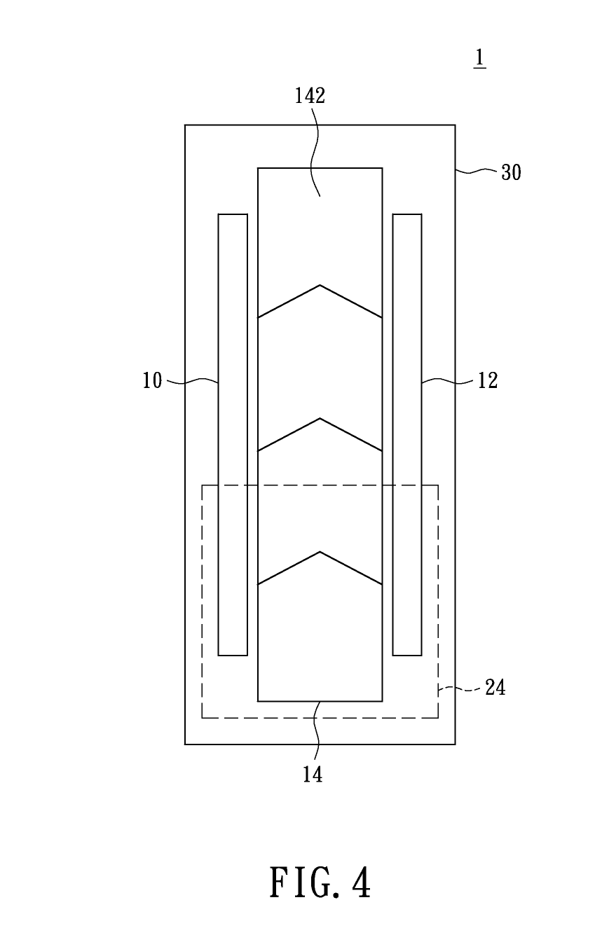

Referring to FIGS. 2 and 4, FIG. 4 shows a top view of a touch device according to another embodiment of the present invention. As shown in the figures, FIG. 4 further defines a third touch-sensing area 24. The control module 18 may receive the first touch signal, at least one third touch signal, the second touch signal in sequence (or in the reversed sequence) when the first touch-sensing unit 10, the touch-sensing strip module 14, and the second touch-sensing unit 12 are touched in the same sequence (or in the reversed sequence). Therefore, the control module 18 can control the electronic device 2 to perform a specific function.

For example, when the third touch-sensing area 24 is touched (i.e., the first touch-sensing unit 10, the 4^{th} third touch-sensing unit of the touch-sensing strip module 14, and the second touch-sensing unit 12 are touched) the control module 18 may control the electronic device 2 to perform the specific function. Also, when the first touch-sensing unit 10, the 3^{rd} third touch-sensing unit of the touch-sensing strip module 14, and the second touch-sensing unit 12 are touched, the control module 18 may control the electronic device 2 to perform another specific function. Therefore, the touch device 1 is not be limited to the 2-axis touch control, but may be capable of facilitating three- (or more) axis touch control.

[Embodiment for Touch Device Having a Housing]

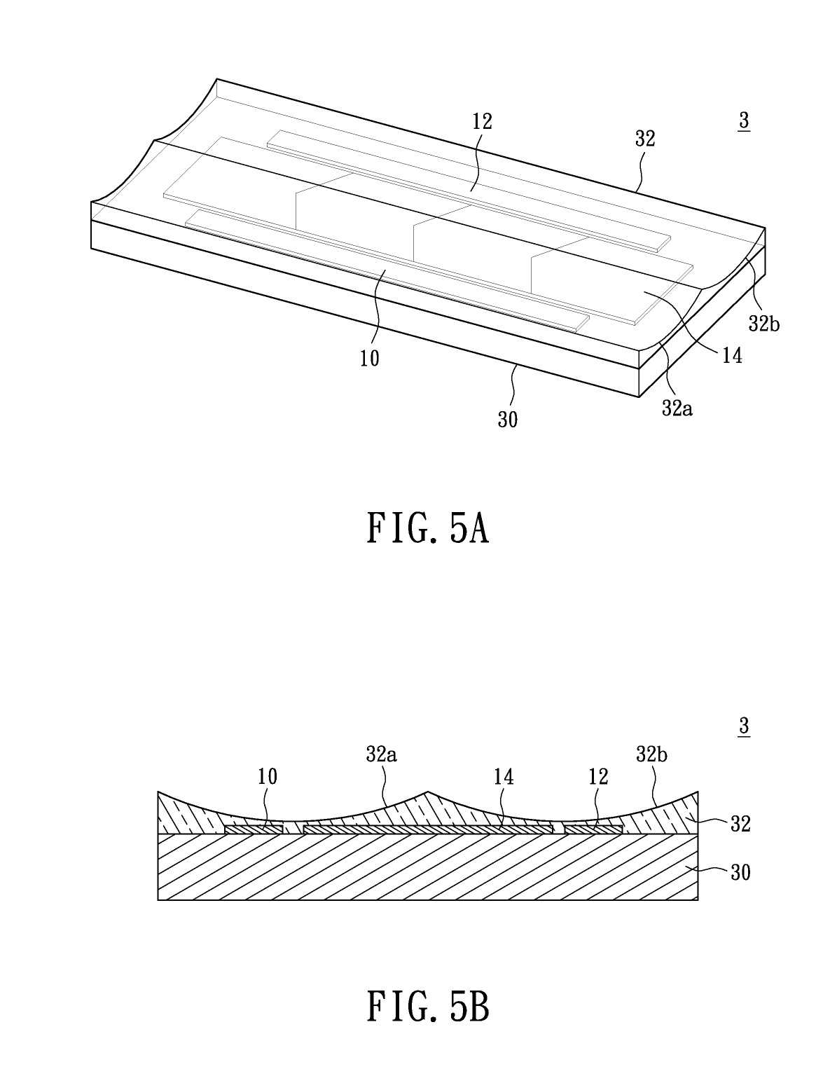

Referring to FIGS. 5A and 5B, FIG. 5A shows a perspective diagram of a touch device with a housing according to an embodiment of the present invention. FIG. 5B shows a sectional diagram of the touch device with the housing according to FIG. 5A. As shown in the figures, the first touch-sensing unit 10, the second touch-sensing unit 12, and the touch-sensing strip module 14 of the touch device 3 are disposed on the same side of a substrate 30. The touch device 3 further has a housing 32 for containing the first touch-sensing unit 10, the second touch-sensing unit 12, and the touch-sensing strip module 14. The present invention intends no limitation upon the material or shape of the housing 32, so long as the housing 32 does not negatively affect the sensing of the first touch-sensing unit 10, the second touch-sensing unit 12, or the touch-sensing strip module 14.

On an exterior surface of the housing 32 a first groove 32a and a second groove 32b are defined. The first groove 32a and the second groove 32b are adapted to align the direction of the sliding. More specifically, the location of the first groove 32a may correspond to the location of the first touch-sensing area 20, so that the first groove 32a could help ensure the first touch-sensing unit 10 and the touch-sensing strip module 14 could be simultaneity touched. The location of the second groove 32b may correspond to the location of the second touch-sensing area 22, so as to help ensure the second touch-sensing unit 12 and the touch-sensing strip module 14 could be simultaneity touched.

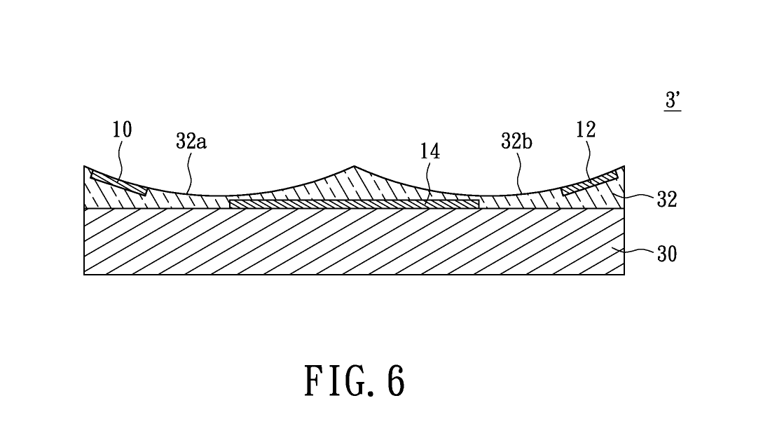

The first touch-sensing unit 10 and the second touch-sensing unit 12 may be, not coplanarly, disposed around the first groove 32a and the second groove 32b, respectively. Please refer to FIG. 6 in which a sectional diagram of a touch device with the housing according to another embodiment of the present invention is illustrated. As shown in FIG. 6, the first touch-sensing unit 10 and the second touch-sensing unit 12 are disposed relatively away from each other. Under this arrangement, the first touch-sensing unit 10 and the second touch-sensing unit 12 may not interfere with each other, eliminating the necessity of the placement of the comparing module.

For example, when any touching (such as sliding downwardly or upwardly) falls within the first groove 32a and is sensed by the first touch-sensing unit 10 and the touch-sensing strip module 14, the first touch-sensing unit 10 and the touch-sensing strip module 14 may thus output the first touch signal and the first sliding signal or the second sliding signal to the control module corresponding to the sliding direction operated by the user. The control module may further control the electronic device to perform the first function (or the second function) when the control module detects the first touch signal (or the second sliding signal) and the first sliding signal at the same time.

To sum up, the touch device of the present invention can realize the 2-axis touch control by disposing the first touch-sensing unit on one side of the touch-sensing strip module and disposing the second touch-sensing unit on the other side of the same touch-sensing strip module. And the first axis is defined by the first touch-sensing unit and the touch-sensing strip module with the second touch-sensing unit and the touch-sensing strip module defining the second axis. In addition, the first touch-sensing unit, the third touch-sensing units of the touch-sensing strip module, and the second touch-sensing unit collectively may equip the touch device according to the present invention with another axis control. When the touch-sensing strip module of the touch device according to the present invention may be share-able in the context of the axis control, the amount of the touch-sensing strip modules and the touch-sensing units could be significantly reduced.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A touch device for controlling an electronic device, comprising:
a first touch-sensing unit for generating a first touch signal when touched;
a second touch-sensing unit for generating a second touch signal when touched;
a touch-sensing strip module, having M third touch-sensing units arranged in series, for generating a first sliding signal while the M third touch-sensing units are touched in a first predetermined sequence; and
a control module, coupled with the first touch-sensing unit, the second touch-sensing unit, and the touch-sensing strip module respectively, for controlling the electronic device to perform a first function while detecting the first touch signal and the first sliding signal at the same time, and for controlling the electronic device to perform a second function while detecting the second touch signal and the first sliding signal at the same time;
wherein M is an integer larger than 1.

2. The touch device according to claim 1, further comprising:
a comparing module, coupled with the first touch-sensing unit, the second touch-sensing unit, and the control module, for comparing a magnitude of the first touch signal and the second touch signal, and transmitting one of the first touch signal and the second touch signal with the larger magnitude to the control module.

3. The touch device according to claim 2, wherein the magnitude of the first touch signal and the second touch signal are determined by capacitance variations of the first touch-sensing unit and the second touch-sensing unit;
when the capacitance variation of the first touch-sensing unit is larger than the capacitance variation of the second touch-sensing unit, the magnitude of the first touch signal is determined larger;
otherwise the magnitude of the second touch signal is determined larger.

4. The touch device according to claim 1, wherein the first touch-sensing unit, the second touch-sensing unit, and the touch-sensing strip module are coplanarly disposed on a substrate, and the touch-sensing strip module is disposed between the first touch-sensing unit and the second touch-sensing unit.

5. The touch device according to claim 1, wherein the k^{th} third touch-sensing unit generates a k^{th} third touch signal when touched, the (k+1)^{th} third touch-sensing unit generates a (k+1)^{th} third touch signal when touched, and the touch-sensing strip module generates the first sliding signal when the touch-sensing strip module detects the k^{th} third touch signal before detecting the (k+1)^{th} third touch signal, wherein both k and k+1 are integers larger than 1 and smaller than M.

6. The touch device according to claim 5, wherein when the touch-sensing strip module detects the k^{th} third touch signal before detecting the (k+1)^{th} third touch signal and further determines a presence of a first time interval between the detected k^{th} third touch signal and the detected (k+1)^{th} third touch signal, the touch-sensing strip module generates a first sliding speed signal.

7. The touch device according to claim 1, wherein the touch-sensing strip module generates a second sliding signal while the M third touch-sensing units being touched in a second predetermined sequence, the control module controls the electronic device to perform a third function while detecting the first touch signal and the second sliding signal at the same time, and the control module controls the electronic device to perform a fourth function while detecting the second touch signal and the second sliding signal at the same time.

8. The touch device according to claim 7, wherein the k^{th} third touch-sensing unit generates a k^{th} third touch signal when touched, the (k−1)^{th} third touch-sensing unit generates a (k−1)^{th} third touch signal when touched, and the touch-sensing strip module generates the second sliding signal when the touch-sensing strip module detects the k^{th} third touch signal before detecting the (k−1)^{th} third touch signal, wherein both k and (k−1) are integers smaller than M with (k−1) larger than 1.

9. The touch device according to claim 8, wherein when the touch-sensing strip module detects the k^{th} third touch signal before detecting the (k−1)^{th} third touch signal and further determines a second time interval between the detected k^{th} third touch signal and the detected (k−1)^{th} third touch signal, and the touch-sensing strip module generates a second sliding speed signal.

10. The touch device according to claim 1, wherein the control module controls the electronic device to perform a fifth function while detecting the first touch-sensing unit, the k^{th} third touch-sensing unit, and the second touch-sensing unit are touched sequentially, wherein k is an integer not larger than M.

11. The touch device according to claim 1, further comprising:
a housing for containing the first touch-sensing unit, the second touch-sensing unit, and the touch-sensing strip module, an exterior surface of the housing having a first groove and a second groove, the first groove being configured to ensure the first touch-sensing unit and the touch-sensing strip module are simultaneity touched, the second groove being configured to ensure the second touch-sensing unit and the touch-sensing strip module are simultaneity touched.
